(19) United States
(12) Patent Application Publication
(10) Pub. No.: US 2013/0147627 A1
(43) Pub. Date: Jun. 13, 2013

(54) FIRE MONITORING SYSTEM

(71) Applicant: Conny Svenning, Malmo (SE)

(72) Inventor: Conny Svenning, Malmo (SE)

(73) Assignee: VCFIRE SYSTEM AB, Malmo (SE)

(21) Appl. No.: 13/698,766

(22) PCT Filed: May 18, 2011
(86) PCT No.: PCT/SE11/50629

§ 371 Date: Jan. 31, 2013

(30) Foreign Application Priority Data
May 19, 2010 (SE) 1000531-2

(51) Int. Cl. G08B 17/00

(52) U.S. Cl. CPC G08B 17/00
USPC 340/584

(57) ABSTRACT

A fire monitoring system having a first fire detector including a first passive sensor and first electronic circuitry, wherein the first passive sensor is arranged in a first fire cell and the first electronic circuitry is arranged outside the first fire cell and coupled to the first passive sensor. A method for monitoring a fire by means of a first fire detector having a first passive sensor and first electronic circuitry, the method including providing first data from the first passive sensor arranged in a first fire cell to the electronic circuitry arranged outside the first fire cell.

### TECHNICAL FIELD The present invention relates to a fire alarm and monitoring system and a method for generating an alarm and monitoring a fire.

### BACKGROUND

Traditional fire alarm systems have a central module placed somewhere in a building and a number of more or less advanced fire detectors dispersed in the building. The detectors comprise sensors, electronics and some type of connection to the central module, normally in the form of a cable. The purpose of the detector is to detect smoke or fire and then transmit an alarm signal to the central module. The central module then transmits an alarm signal to an alarm center, which in turn sends out the fire brigade, ambulance, police and/or any other party needed. Traditional fire alarm systems are vulnerable in the sense that neither the fire detectors nor the central module are made to handle high temperatures.

### SUMMARY OF THE INVENTION

In view of the above, it is an objective of the present invention to provide a method and system for fire monitoring which overcomes the drawbacks of the prior art fire monitoring systems. Further objectives involve providing a more flexible and effective method and system for fire monitoring.

In order to achieve at least one of these objectives, and also additional objectives which will become evident from the following description, the present invention provides a fire monitoring system according to claim 1 and a method for monitoring a fire according claim 14.

In particular, according to a first aspect of the invention, a fire monitoring system comprises a first fire detector comprising a first passive sensor and first electronic circuitry, wherein the first passive sensor is arranged in a first fire cell and the first electronic circuitry is arranged outside the first fire cell and coupled to the first passive sensor.

According to this arrangement an improved system for monitoring a fire is achieved. Normally a fire detector will function up to a temperature below 100° C. This is due to the fact that the electronic circuitry inside a fire detector cannot handle high temperatures. By having the sensitive electronic circuitry positioned outside a fire cell it is possible to monitor a high temperature during a longer time interval since the passive sensor being placed inside the fire cell is capable of handling higher temperatures than the electronic circuitry.

According to one embodiment the passive sensor is operational above 300 degrees.

Instead of the possibility to only monitor a temperature below 100° C., it is possible to monitor a temperature above 300° C. using the passive sensor.

According to another embodiment the passive sensor is a temperature sensor, ultra violet (UV) sensor, ultra sonic sensor and/or smoke sensor.

This allows monitoring of other parameters besides ambient temperature. For example an UV sensor can be used to detect heat radiation, an ultra sonic sensor can be used to detect movement and a smoke sensor can be used to detect smoke.

In one embodiment the electronic circuitry is arranged to receive first data from the passive sensor.

The electronic circuitry may sample the passive sensor to retrieve information about the temperature or another parameter that depends on the sensor type.

In another embodiment the fire monitoring system comprises a server coupled to the electronic circuitry.

In yet another embodiment the server is arranged to receive second data from the electronic circuitry and log the second data, the second data being based on the first data.

The server collects data from various fire detectors, wherein each fire detector comprises electronic circuitry. The server also has the capacity of logging the data it receives. The stored data makes it possible to retrieve historical data from various fire cells in which the fire detectors may be placed.

According to one embodiment the server is adapted to transmit the second data to a third party.

The data collected at the server can be sent further to a third party. A “third party” should, in the context of the present application, be understood as a party being interested in the information about for example the temperature distribution and development in a building. This information is for example interesting for the fire brigade and/or the alarm center. The fire brigade and the alarm center will both be considered as a third party.

According to another embodiment the server is adapted to transmit a subset of the second data.

It may be that not all collected information from the fire detectors are relevant and the server may therefore select relevant data. The selected data may be transmitted to for example a third party. The benefit of reducing the amount of data is dependent on the capacity of the connection between the server and the third party. A slower connection would require a more careful selection of data.

According to yet another embodiment the system comprises a display unit arranged to receive the second data.

The alarm center and the fire brigade could use a portable unit, such as tablet PC, iPad or the like to monitor the development of a fire during their ride to the place where the alarm was triggered. The display unit receives information about the current status received from the server and the fire brigade may be better prepared with countermeasures at their arrival to the place.

In another embodiment the display unit is arranged at the third party.

This allows the alarm center to determine the amount of personnel, vehicles that the fire brigade may need in a place having an ongoing alarm and/or a fire.

According to one embodiment the fire detector is arranged to continuously transmit the second data to the server during a time interval.

A continuous transmission is beneficial when the system is idle to check if the system is functioning properly. The continuous transmission is also beneficial during an alarm to retrieve information about for example how a temperature is developing in a fire cell.

By “continuously” should, in the context of the present application, be understood as a way of continuously transmitting information originating from the passive sensor to the server. The time interval between each transmission may be set to either a predetermined time interval or a random time interval. The time interval may be different when the system is in idle mode compared to an alarm mode. This could for example mean that the time interval between transmissions is smaller during an alarm since the need for updates of the data used for monitoring during an alarm is higher.

According to another embodiment the server is arranged to provide 3D images based on the second data to the display unit.

The use of 3D images allows for a better visual view of the building and the determination of where an alarm is triggered and how a fire is evolving.

In one embodiment the fire monitoring system comprises a second fire detector comprising a second passive sensor and second electronic circuitry, wherein the second passive sensor is arranged in a second fire cell together with the first electronic circuitry and the second electronic circuitry is arranged outside the first and second fire cell and coupled to the second passive sensor.

A fire cell contains a passive sensor capable of handling high temperature. The electronic circuitry is placed outside this fire cell. However, the fire may begin or progress into the area where the electronic circuitry is placed. Therefore, an additional passive sensor is placed in the same area where the electronic circuitry is placed. Furthermore an additional electronic circuitry is placed outside this area. Therefore, each area will be treated as a fire cell having electronic circuitry placed outside this area.

According to another aspect of the invention, a method for monitoring a fire by means of a first fire detector comprising a first passive sensor and first electronic circuitry, the method comprising providing first data from the first passive sensor arranged in a first fire cell to the electronic circuitry arranged outside the first fire cell.

According to this arrangement an improved method for monitoring a fire is achieved. Normally a fire detector will send an alarm when a fire is detected and shortly thereafter it will burn. This method uses passive sensor that provide data during a longer time interval since the passive sensors can withstand much higher temperatures. This in combination with the electronic circuitry placed outside a fire cell allows for a longer monitoring time at higher temperatures.

According to an embodiment, the method further comprises that the first data is provided from the first passive sensor operating at a temperature above 300 degrees.

The benefit with the passive sensors is that they are capable of providing information much longer than ordinary fire detectors.

According to another embodiment, the method further comprises that the first data correspond to a temperature, ultra violet, UV, emission movement and/or smoke, detected by the first passive sensor.

This allows the system to monitor other parameters besides temperature.

According to yet another embodiment, the method further comprises receiving second data from the electronic circuitry in a server and logging the second data at the server, the second data being based on the first data.

Storing the data allows retrieving historical data. The historical data may be needed by the fire brigade to determine for example the origin of a fire and/or how the fire has progressed before they received the alarm.

In one embodiment the method further comprises transmitting the second data to a third party from the server.

The data transmitted from the server may be used by a third party in order to for example determine proper countermeasures.

In another embodiment the method further comprises transmitting a subset of second data from the server.

Submitting subsets of data requires less bandwidth and may hence be used in connections having low bandwidth.

In yet another embodiment the method further comprises receiving the second data in a display unit.

Display units allows for easier visualization of the building and the fire.

According to an embodiment the method further comprises continuously transmitting second data to the server from the fire detector during a time interval.

According to another embodiment the method further comprises providing 3D images based on said second data to said display unit from said server.

### BRIEF DESCRIPTION OF DRAWINGS

These and other aspects of the present invention will now be described in more detail, with reference to the appended drawings showing exemplary embodiments of the invention. The figures should not be considered limiting the invention to the specific embodiment; instead they are used for explaining and understanding the invention.

FIG. 1 is a schematic view of the system according to an embodiment of the present invention.

FIG. 2 is a schematic view of the system in standby mode according to an embodiment of the present invention.

FIG. 3 is a schematic view of the system in fire alarm mode according to an embodiment of the present invention.

FIG. 4 is a schematic view of the system in fire monitoring mode according to an embodiment of the present invention.

### DETAILED DESCRIPTION

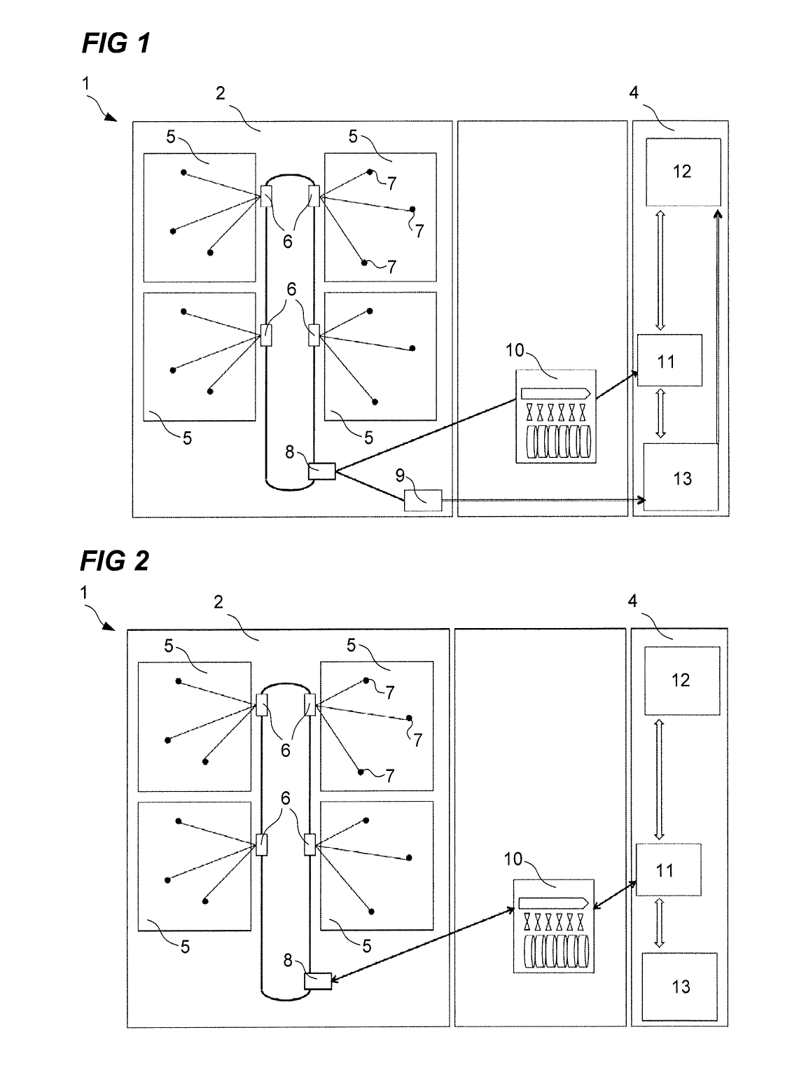

FIG. 1 shows a schematic view according to an embodiment of the invention, suitable for monitoring a fire.

The fire monitoring system 1 is arranged to monitor a fire and its development in for example a building 2. At the same time, the fire brigade being on its way to stop the fire may use the information about how the temperature is changing in various areas in the building 2 to prepare appropriate counter measure.

The fire monitoring system 1 comprises a fire detector, wherein the fire detector further comprises a sensor 7 and electronic circuitry 6. The sensor 6 is arranged in a fire cell 5 and the electronic circuitry 6 is arranged outside this fire cell 5. The sensor 7 is connected to the electronic circuitry 6.

The sensor 7 used in the fire detector is a passive sensor 7 capable of measuring various parameters such as temperature, ultra violet emission or smoke. The passive sensor 7 may also detect movement using ultra sonic technology. Typically the passive temperature sensor 7 is capable of measuring temperatures up to and above 300 degrees and in most cases capable of measuring temperatures up to 800 degrees. One type of sensor that may be used is a pt100 sensor in ceramic, which can withstand temperatures up to 850 degrees Celsius. The electronic circuitry 6 is placed outside the fire cell and collects information from the passive sensor 7 by sampling the passive sensor 7 at predetermined intervals. The electronic circuitry 6 may be based on micro controllers, one-chip computers or the like. It should be noted that one electronic circuitry 6 may be connected to one or more passive sensors 7.

The passive sensor 7 and the electronic circuitry 6 belonging to a fire detector are not mounted at the same place. The passive sensor 7 is arranged within a fire cell and the electronic circuitry 6 is arranged outside the fire cell 5. The passive sensor 7 is connected to the electronic circuitry 6 using high temperature resistant cables. The cables are capable of handling temperatures above the operational temperatures of the passive sensor 7. The reason of using this type of cables is to avoid malfunction of the system due to the cable being burned before the passive sensor 7. One type of cable that could be used is a fire rated cable called Red lead that can withstand temperatures up to 900 degrees Celsius. The cable may be placed in tubes inside walls and/or ceilings where possible.

Each passive sensor 7 is placed in a fire cell 5. A building 2 comprises several fire cells 5 and one or more passive sensors 7 may be positioned in each of these fire cells 5. An area outside a fire cell 5, but still within a building 2, may also be considered as a fire cell 5 in itself. The term fire cell 5 should be understood as a broadly defined term in the context of this application. A fire cell 5 may be a room in a building 2, an open office space, stairways, etc. In other words a fire cell 5 is a defined area inside a building 2. The walls defining a fire cell 5 may limit a fire a defined set of minutes.

The fire monitoring system 1 as illustrated in FIG. 1 comprises several fire detectors. A first fire detector is related to a first fire cell 5 in the sense that a first passive sensor 7 is placed inside the fire cell 5 and a first electronic circuitry 6 is placed outside the first fire cell 5, e.g. in a second fire cell 5. In the second fire cell 5 a second passive sensor 7 is arranged. The second passive sensor 7 in the second fire cell 5 is connected to a second fire detector and a second electronic circuitry 6. The second electronic circuitry 6 is arranged outside the second fire cell 5.

As mentioned above, it should be noted that a fire detector comprising a passive sensor 7 and electronic circuitry 6 does not have its passive sensor 7 and its electronic circuitry 6 arranged at the same physical position. A fire cell 5 may include a first passive sensor 7 being connected to a first electronic circuitry 6 and a second electronic circuitry 6 connected to a second passive sensor 7, wherein the first electronic circuitry 6 and the second passive sensor 7 are mounted in the same housing.

In one embodiment each electronic circuitry 6 is connected to another electronic circuitry 6. If one electronic circuitry 6 brakes, another electronic circuitry 6 may receive data from the passive sensors 7 being connected to the first electronic circuitry 6. The electronic circuits 6 are connected to each other in a bus configuration. The bus arrangement has the benefit that if a cable connecting two electronic circuits 6 is broken, another cable route may be used to keep the system up and running.

The electronic circuits 6 in each fire detector in the fire monitoring system 1 are connected to a computer 8 that may distribute data collected from the passive sensors 7. The computer 8 collects the data from the electronic circuits 6 and transmits them to a server 10. The system 1 may be configured to function without a computer 8, thus having each electronic circuitry 6 connected to a server 10. The purpose of having a computer 8 is to have a single communication line between the building 2 being monitored and the server 10. The computer 8 may be placed inside the building 2 or in a distant place from the building 2. The computer 8 also determines if a signal should be sent to an alarm transmitter 9 being connected to the computer 8.

The alarm transmitter 9 receives information from the computer 8 about an alarm and sends the fire alarm to the alarm center 13. It should be noted that the alarm transmitter 9 may be incorporated in the computer 8.

The server 10 being connected to a building 2 either through a computer 8 or directly to each electronic circuit 6 in that building 2 may be positioned anywhere in the world. It may be a virtual type of server 10. The server 10 receives data from each building 2 it is connected to and logs all or part of the received information. The server 10 will stream information about the fire development to a third party 4. The server 10 further includes programs and/or algorithms that are to be used for determining if the system 1 is running properly or to select the type of data that is to be sent further to a third party 4. The server 10 comprises two types of data, static data and dynamic data,

Static data is registered at the server 10 and includes information regarding a building 2 and in some cases the surroundings of the building 2. The static data may include information about the position of fire posts, emergency exits, keys or codes to enter the building or area and floor plans of the building 2. The floor plans may be registered as images.

Dynamic data is continuously registered at the server 10 and includes information about either temperatures, ultra violet emissions, movements, smoke and/or a combination of one or more of these parameters.

A display unit may be connected to the fire monitoring system 1. The display unit receives static data and dynamic data from the server. Alternatively the dynamic data and the static data may be combined at the server side before transmitted to the display unit. The display unit may be a portable device having a display, such as a tablet PC, iPad, smartphone, laptop etc.

The alarm center 13, the fire brigade 12 or any other party receiving data from the server are to be considered as a third party 4. In the shown embodiment a fire brigade 12 and an alarm center is the third party 13. Third party 4 may also include other fire brigades, the police, ambulance or any other types of actors needed or interested in the fire and its development.

In the illustrated embodiment an interface 11 is used between the server 11 and third party 4, however, it is to be understood that the server 10 may be connected directly to an alarm center 13 and/or the fire brigade 12.

FIGS. 2-4 show schematic views of the fire monitoring system 1 in standby mode, fire alarm mode and fire monitoring mode according to an embodiment of the present invention.

In standby mode as shown in FIG. 2 the fire monitoring system 1 uses a number of fire detectors having electronic circuitry 6, wherein each electronic circuitry 6 has a number of passive sensors 7 connected to it. A computer 8 is connected in a looped configuration together with the electronic circuits 6. The computer 8 is connected to the server 10 and the server 10 is connected to an alarm center 13 and/or the fire brigade 12 through an interface 11.

The electronic circuitry 6 continuously samples the passive sensor 7, in the shown embodiment being a temperature sensor 7. A signal is sent to the computer 8 from the electronic circuitry 6 indicating if the sensor 7 is functioning properly.

The computer 8 continuously sends a signal to the server 10 during the standby mode indicating that the system 1 is functioning. It is realized that in some cases the computer 8 may be replaced by the electronic circuitry 6 itself. In this case the electronic circuitry 6 both samples and communicates with the server 10.

The server 10 also communicates with the third party 4 to determine if the connection between the server 10 and the third party 4 is functioning.

The server 10 receives information from the computer 8 and from the third party 4. If no information is received from either the computer 8 or the third party 4, the server 10 will consider the system 1 and the connection to be malfunctioning. The server 10 will then indicate this by calling for service support, either directly or through another party.

The computer 8 may also send an error signal indicating that one or several parts of the fire monitoring system 1 are malfunctioning. This could for example be a broken sensor, an electronic circuitry not responding etc. The server calls for an installation service provider, a technician or the like in order to repair the faulty part.

Finally, the computer 8 may send an alarm signal indicating a fire. The fire monitoring system 1 will be set in a fire alarm mode.

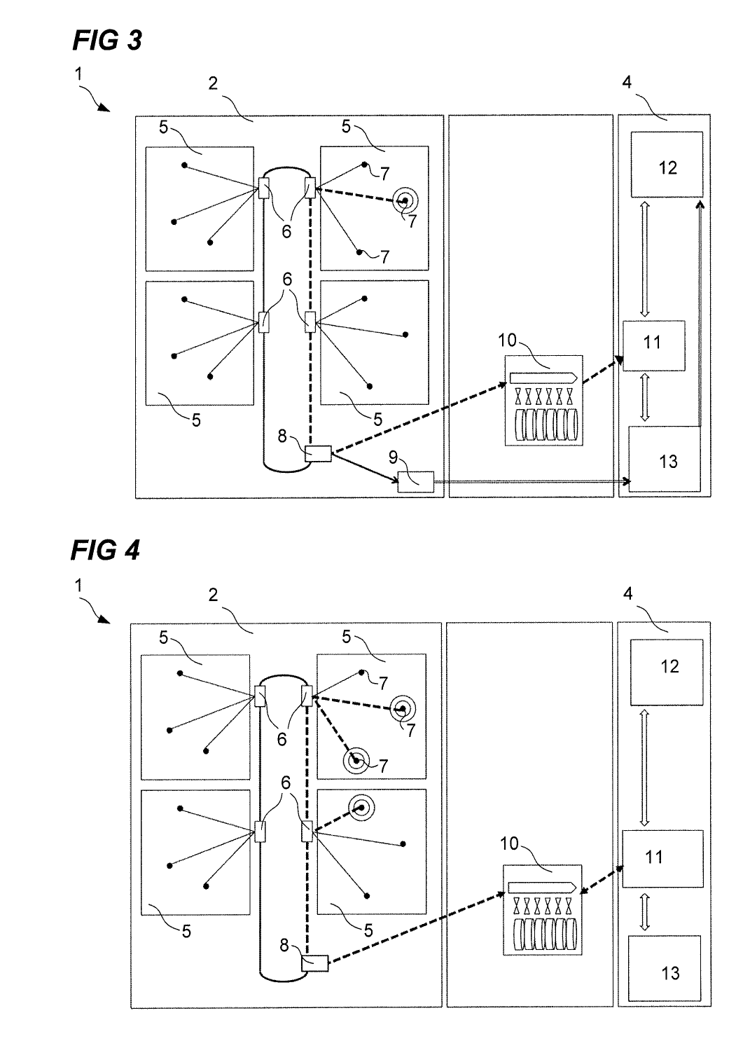

FIG. 3 shows the fire monitoring system 1 in a fire alarm mode.

An electronic circuitry 6 has in the shown embodiment sampled a temperature sensor 7. The temperature sensor 7 has responded with a temperature value that has passed a predefined threshold value.

The threshold value may be set to a fixed degree or as variation away from an average value or any other type of threshold value suitable for the specific fire cell 5.

The electronic circuitry 6 will send information about the temperature as well as the identity of the sensor 7 to the computer 8. The identity of the sensor 7 is to be used for locating the sensor 7.

The computer 8 will now send a signal to an alarm transmitter 9 or directly to an alarm center 13. The computer 8 will also send dynamic data including the temperature information and the identity information to the server 10.

The server 10 registers the received information and registers the received data as dynamic data. The server 10 retrieves static data information from its database and combines this data with the dynamic data. The server 10 then sends the combined data in the form of images or to a 3D modeling interface 11 and further on to the third party 4. The combined data may be either raw data or images depending on the configuration of the server 10.

It is realized that the 3D models may be generated directly at the server side and sent directly to the third party 4 using push technology.

The fire monitoring system 1 will thereafter enter a fire monitoring mode.

FIG. 4 shows the fire monitoring system 1 in a fire monitoring mode.

When the system 1 enters a fire monitoring mode, all fire detectors are activated. In the case of very large buildings 2 or large areas that are monitored, the fire detector, or a number of fire detectors, that are adjacent to an alarming fire detector may be sufficient to activate.

The electronic circuitry 6 for each fire detector will now continuously sample the temperature sensors 7 according to a predefined scheme. The time interval may be shorter in the fire monitoring mode compared to the standby mode in order to retrieve samples more frequently in the fire monitoring mode.

The electronic circuits 6 send information about temperatures and identities for each temperature sensor to the computer 8.

The computer 8 will transmit this information further to the server 10.

The server 10 registers the received information and registers the received data as dynamic data. The server 10 retrieves static data information from its database and combines this data with the dynamic data. The server 10 then sends the combined data to a 3D modeling interface and further on to the third party 4. The combined data may be either raw data or images depending on the configuration of the server 10.

The server 10 will continuously send data to the third party 4 during fire monitoring mode. The server 10 may also send historical data from the time before the fire brigade 12 started to observe the fire.

It should be noted that the server 10 is capable of handling multiple connections and able to communicate with several parties in order to handle several ongoing fires.

The server 10 may also include data from other similar fires or older fires in the same building 2. The server 10 may include programs or algorithms that can calculate and/or predict the fire and its development. All this information may be submitted to the third party 4 if required by the third party 4.

The person skilled in the art realizes that the present invention by no means is limited to the embodiments described above. Many modifications and variations are possible within the scope of the appended claims.

1. A fire monitoring system (1) comprising a first fire detector comprising a first passive sensor (7) and first electronic circuitry (6), wherein said first passive sensor (7) is arranged in a first fire cell (5) and said first electronic circuitry (6) is arranged outside said first fire cell (5) and coupled to said first passive sensor (7).

2. A fire monitoring system (1) according to claim 1, wherein said passive sensor (7) is operational above 300 degrees.

3. A fire monitoring system (1) according to claim 1 or 2, wherein said passive sensor (7) is a temperature sensor, ultra violet, UV, sensor, ultra sonic sensor and/or smoke sensor.

4. A fire monitoring system (1) according to any one of preceding claims, wherein said electronic circuitry (6) is arranged to receive first data from said passive sensor (7).

5. A fire monitoring system (1) according to any one of preceding claims, comprising a server (10) coupled to said electronic circuitry (6).

6. A fire monitoring system (1) according to claim 5, wherein said server (10) is arranged to receive second data from said electronic circuitry and log said second data, said second data being based on said first data.

7. A fire monitoring system (1) according to any one of claims 5-6, wherein said server (10) is adapted to transmit said second data to a third party (4).

8. A fire monitoring system (1) according to claim 7, wherein said server (10) is adapted to transmit a subset of said second data.

9. A fire monitoring system (1) according to any one of claims 7-8, wherein said system (1) comprises a display unit arranged to receive said second data.

10. A fire monitoring system (1) according to claim 9, wherein said display unit is arranged at said third party (4).

11. A fire monitoring system (1) according to any one of claims 5-10, wherein said fire detector is arranged to continuously transmit said second data to said server (10) during a time interval.

12. A fire monitoring system (1) according to any one of claims 9-11, wherein said server (10) is arranged to provide 3D images based on said second data to said display unit.

13. A fire monitoring system (1) according to claim 1 or 2, comprising a second fire detector comprising a second passive sensor (7) and second electronic circuitry (6), wherein said second passive sensor (7) is arranged in a second fire cell (5) together with said first electronic circuitry (6) and said second electronic circuitry (6) is arranged outside said first and second fire cell (5) and coupled to said second passive sensor (7).

14. A method for monitoring a fire by means of a first fire detector comprising a first passive sensor (7) and first electronic circuitry (6), said method comprising providing first data from said first passive sensor (7) arranged in a first fire cell (5) to said electronic circuitry (6) arranged outside said first fire cell (5).

15. A method for monitoring a fire according to claim 14, wherein said first data is provided from the first passive sensor (7) operating at a temperature above 300 degrees.

16. A method for monitoring a fire according to any one of claim 14 or 15, wherein said first data correspond to a temperature, ultra violet, UV, emission movement and/or smoke, detected by said first passive sensor (7).

17. A method for monitoring a fire according to any one of claims 14-16, comprising receiving second data from said electronic circuitry (6) in a server (10) and logging said second data at said server (10), said second data being based on said first data.

18. A method for monitoring a fire according to any one of claims 14-17, comprising transmitting said second data to a third party (4) from said server (10).

19. A method for monitoring a fire according to claim 18, comprising transmitting a subset of second data from said server (10).

20. A method for monitoring a fire according to any one of claims 14-19, comprising receiving said second data in a display unit.

21. A method for monitoring a fire according to any one of claims 14-20, comprising continuously transmitting second data to said server (10) from said fire detector during a time interval.

22. A method for monitoring a fire according to any one of claims 14-21, comprising providing 3D images based on said second data to said display unit from said server (10).
